(19) United States
(12) Patent Application Publication
(10) Pub. No.: US 2002/0134306 A1
(43) Pub. Date: Sep. 26, 2002

(54) Machine for the horizontal painting of products

(76) Inventors: Bruno Baroncini, Imola (IT); Silver Santandrea, Imola (IT)

Correspondence Address: LARSON & TAYLOR, PLC, 1199 NORTH FAIRFAX STREET, SUITE 900, ALEXANDRIA, VA, 22314, US

(21) Appl. No.: 10/101,845

(22) Filed: Mar. 21, 2002

(30) Foreign Application Priority Data
Mar. 22, 2001 (IT) BO2001A000168

(51) Int. Cl. B05C 5/00

(52) U.S. Cl. 118/621; 118/308

(57) ABSTRACT

The machine for the horizontal painting with powdered paints, of three-dimensional and mainly flat wood products or its by-products, comprises a horizontal and motorised conveyor (1) upon which are resting the products to be painted which by suitable means are referred to an electric potential having a predetermined sign and which by the same conveyor are driven to pass through at least one chamber (11) connected to suction means which maintain the same in depression with respect to the external environment, because in said chamber are delivered by suitable means the powdered paints electrostatically charged with electric charges having an opposite sign to the one of the products, to strictly adhere to the same products. The whole is effected in such a manner that the particles of powder do not exit from the inlet and outlet mouths or doors of said chamber because of the suction effected by said suction means. The delivery means of the electrostatically charged painting powders, are placed at least at one or both of the doors of the said chamber (11), so that are continuously licked up by the depressurisation airflow of the same painting chamber, which prevents the deposit upon said means of powdered paint and which therefore maintains said means always perfectly clean.

### DESCRIPTION

During the realisation of the machine described in the Italian patent application No. BO2000A-278, owned by the same applicant, for the horizontal painting, with powdered paints, of wood products or by-products, tridimensional and with a prevalent flat extension, there are resulted useful some important modifications which form the object of the present patent application. To better understand the objects that the invention proposes, it is useful to remember that the machine which is referred to, was comprising a horizontal conveyor of electrically conducting material, which with its upper portion or run was continuously running with a pre-established direction and upon the initial end of which were deposited the flat products to be painted. Means were provided to place at least the upper portion of said conveyor to a pre-established electric potential, for example negative potential, with reference to the earth, in order to allow the products to be painted would result to a same potential. The conveyor was forming with its upper portion the bottom of a chamber provided at the opposite ends with inlet and outlet mouths or doors for the same products and said chamber was connected to intake means to avoid that from said doors and from the connection zones of the chamber to the upper portion of the conveyor, should come out particles of the powdered paints delivered by the guns placed inside the same chamber and electrostatically charged to a potential such that the same powders should be attracted in a uniform manner by the visible surface of the products which are resting upon the conveyor, charged for example with a positive potential. While the products with the powdered paint are transferred to a next conveyor which insert the same into the plasticization and catalysis oven of the same powdered paint, suitable means take off from the inferior portion of the conveyor of the machine the powder delivered from said painting means and which has not reached the products to be painted.

Machines of this kind, also if differently destined to the painting of metallic products, are for example described in the U.S. Pat. Nos. 4,144,837, 4,901,666, 4,836, 137, 5,240,504, 5,800,615 as well in the European patent EP 858 841 and in the German patents DE 35 16 826 and 43 18 273.

In all the machines for the painting with powders of products placed upon a conveyor, realised according to the prior art, are present the following limitations and drawbacks.

A first problem which has been found out in the prior art, is represented by the fact that the delivery guns for the powdered paints are always placed inside the painting chamber, so that they result relatively close to the product to be painted, but because of this collocation, powders of paint tend in unavoidable manner to accumulate upon the same guns and then can fall creating undesired localised accumulation of paint upon the products in transit. To obviate these drawbacks, in the U.S. Pat. No. 5,800,615 are provided protection surfaces under the guns, having the precise purpose to collect possible powders which are falling from the same guns. These surfaces can on their turn charge with powders, and instead of resolving the problem, contribute to exasperate the problem.

To obviate to these drawbacks in a definitive manner, the invention provides to join the ends of the plurality of the transport tubes of the powdered paints opposite to those which are bundle connected to the electrostatic charging guns, upon an horizontal support structure, placed at the level of at least one or both the ends doors of the same chamber, over and at a short distance from the handworks or products to be painted, so that it is possible to realise painting combs, with the ends of the tubes placed at the same distance and oriented in the direction of the products. With these solution the painting combs are continuously invested with the same current as the flow of the powdered paints delivered by the same combs, from the air which enter from the doors of the painting chamber and which is sucked by the depressurisation means of the same chamber, the whole in such a manner that said combs remain always perfectly clean. The feeding guns for the powdered paints, are placed outside of the painting chamber, in such a manner to be not interested by said powders.

To ensure also a good painting of the sides of the products, the painting combs are placed slanting upon the conveyor, for example with an inclination of about 45°. In a plan view, also the doors of the painting chamber have a such inclination with respect to the conveyor which is crossing the same chamber.

A second drawback derives from the difficulty to electrically charge to a sufficient and uniform potential the surface to be painted of the wood products by means of the simple contact with the conveyor.

To obviate to this drawback, good results have been reached with the use of a synthetic materials conveyor, having at least the external surface with a good conductivity of the electrostatic charges and with the use of a electrostatic charging bar placed transversally, over and at a correct distance from the upper portion of said conveyor, and oriented with its own points downwardly oriented, in a manner to distribute electric or electrostatic charges polarised for example negatively upon the panel and upon the conveyor which are passing under the same bar, to charge them electrostatically with a predetermined electric polarity in an uniform distributed manner.

Providing the delivery combs for the powdered paints upon the opposite ends of a painting chamber, it may occur that the last layer of paint, being sprayed in opposite direction to the advancement direction of the products, may result relatively crisped and not regular. To obviate to drawback, it can be provided to use two painting chambers placed in succession, with the delivery combs for the powdered paints placed at the inlet doors of the two chambers and/or at the outlet door of the first chamber and at the inlet door of the second chamber, so that at least the last painting bar delivers the paints in the same travel direction of the products.

To ensure also a more regular distribution of the powders, it is finally provided to subject the painting combs to a slight alternate movement along their longitudinal axis or transversally to the conveyor.

These and other features of the invention, and the advantages deriving therefrom, will appear better evident from the following description of a preferred embodiment of the same, made by way of non-limiting example, with reference to the figures of the seven attached sheets of drawings, in which:

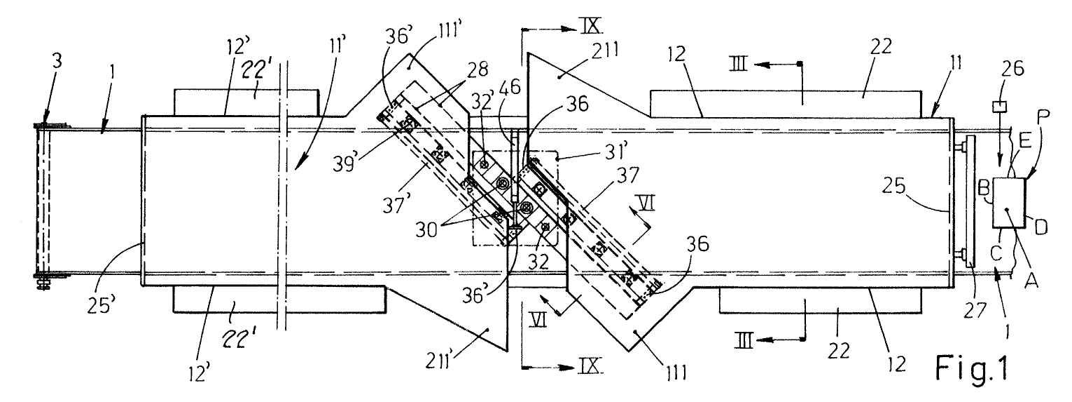

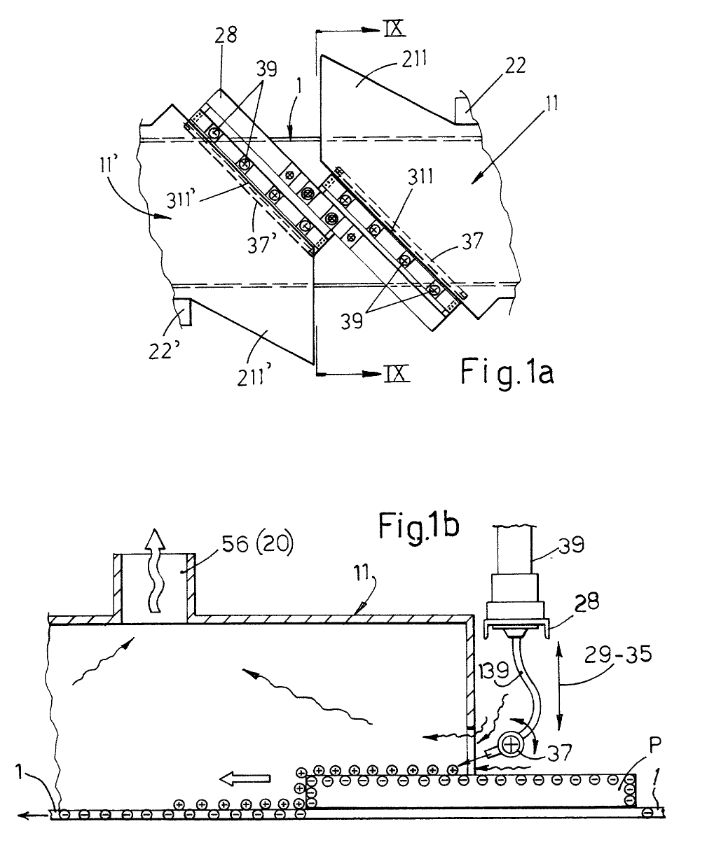

FIG. 1 is a schematic and plan view from the top of the machine according to a first embodiment;

FIG. 1a is a schematic and plan view of the intermediate portion of the machine according to a constructive variant;

FIG. 1b shows schematically principle details of the machine longitudinally sectioned and from a side-view;

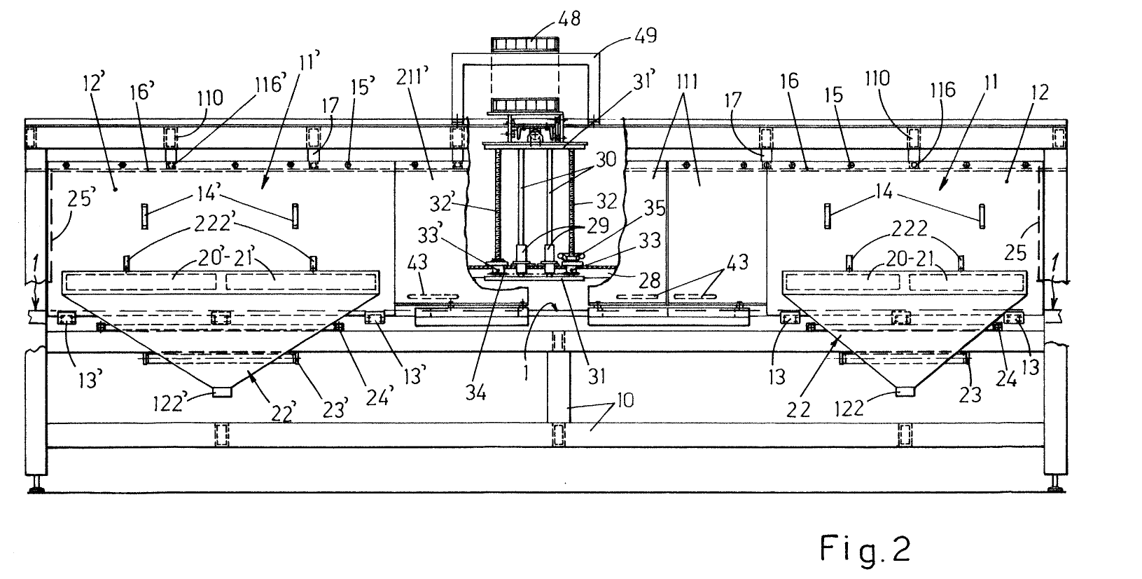

FIG. 2 is a lateral view of the machine as from FIG. 1, partially broken and sectioned in the intermediate portion where are placed the painting means;

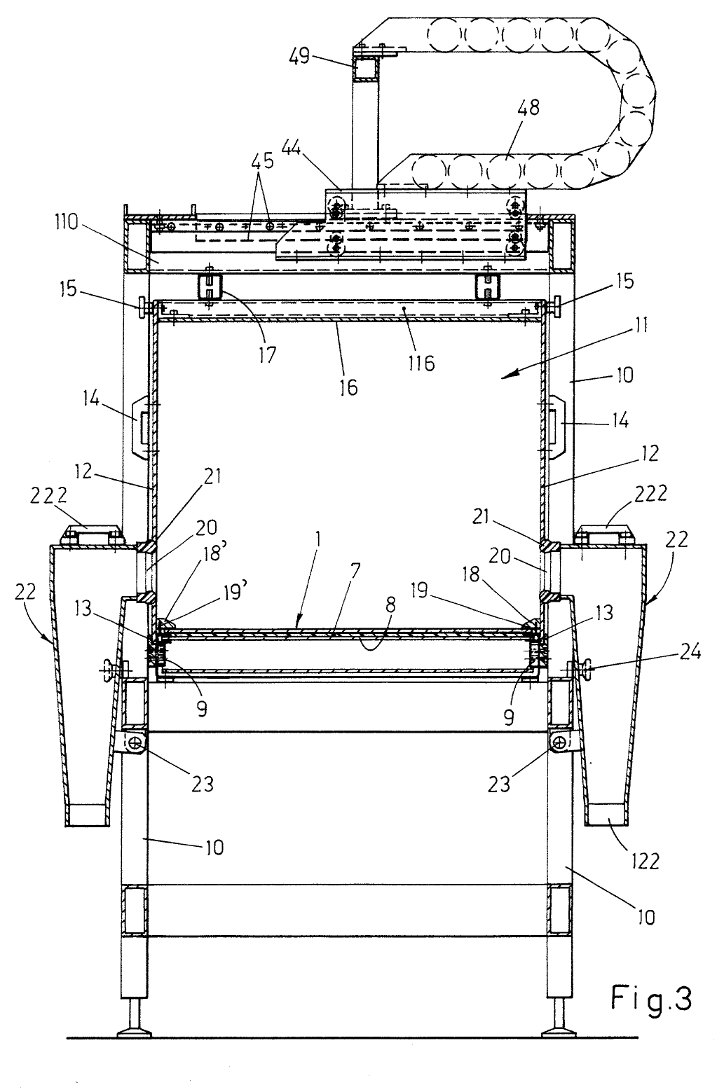

FIG. 3 shows further details of the machine transversally sectioned according to the line III-III of FIG. 1;

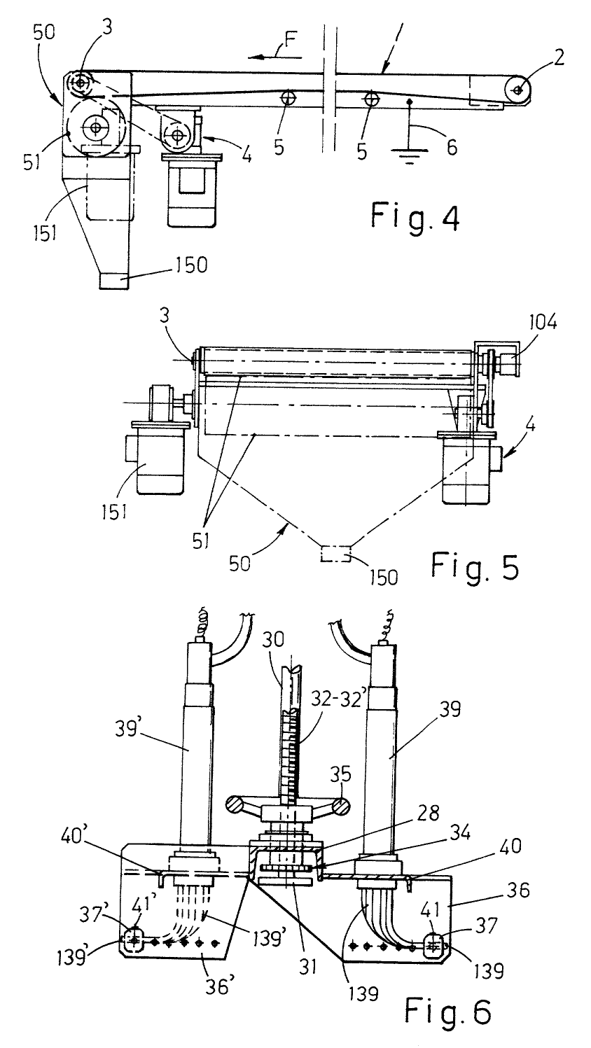

FIG. 4 is a lateral view of the conveyor with the relative final cleaning means;

FIG. 5 is a frontal view of the conveyor with the cleaning means of FIG. 4;

FIG. 6 shows details of the painting unit transversally sectioned according to the line VI-VI of FIG. 1;

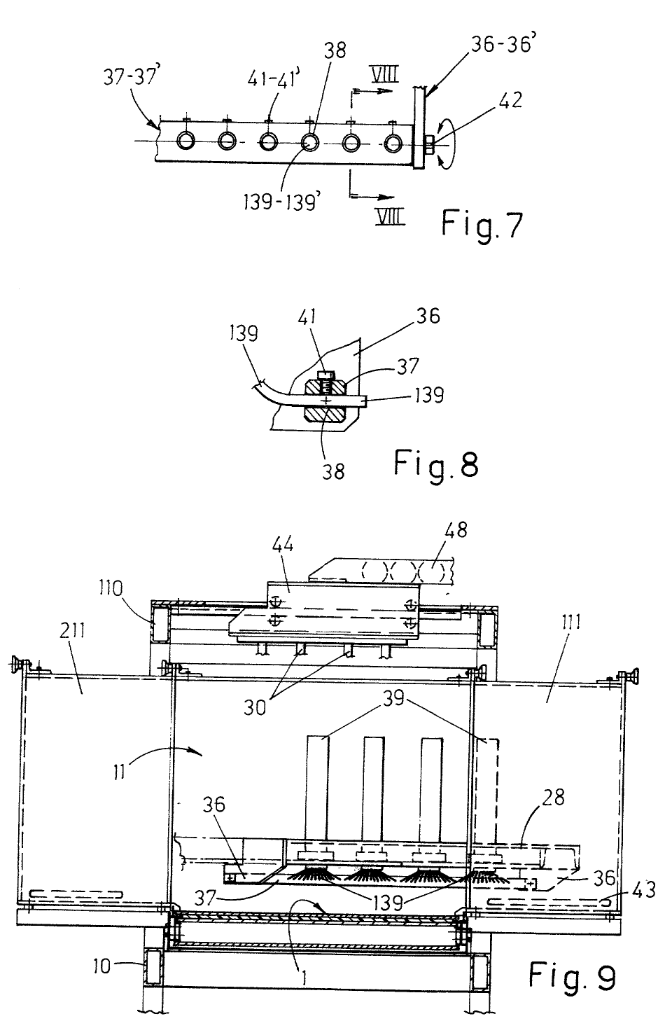

FIG. 7 shows frontally one of the painting bars;

FIG. 8 shows further details of the bar of FIG. 7 sectioned along the line VIII-VIII;

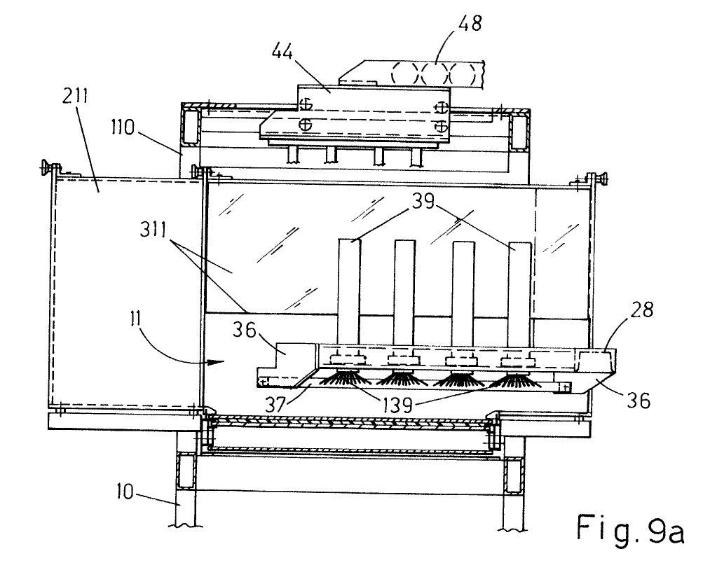

FIG. 9 shows details of the first painting unit obtained according to the section IX-IX of FIG. 1;

FIG. 9a shows details of the first painting unit obtained according to the section IX-IX of FIG. 1a;

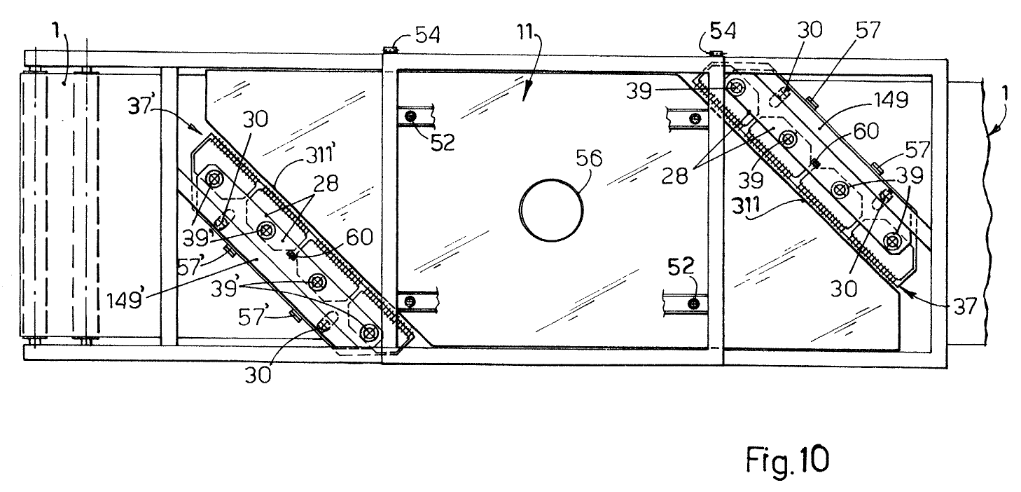

FIG. 10 is a schematic and in plan view of the machine in the version with a single painting chamber

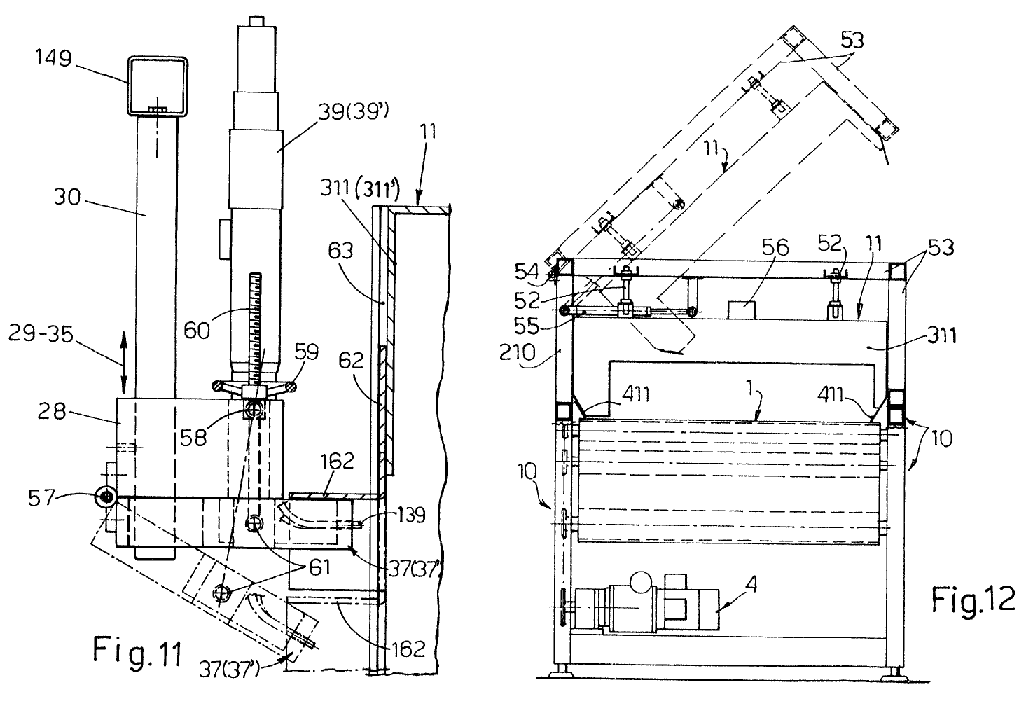

FIG. 11 shows in lateral elevation part of a painting unit placed on one of the ends of the chamber of the machine as from FIG. 10;

FIG. 12 is a frontal view of the machine of FIG. 10, with the painting chamber illustrated with dotted line in the raised position for the inspection and the cleaning.

From FIGS. 1, 2, 3, 4 it is noted that according to a first embodiment which comprises all the improvements which are referred to, the machine is provided with a horizontal band conveyor, realised with any suitable synthetic materials which guarantee a good mechanical resistance, a good level of electric insulation and a good surface conductivity of the electrostatic charges, said conveyor being wound on end rollers 2 and 3, the first of which is neutral while the other is connected to a continuous motorization unit 4 which drives the superior section of the conveyor for example in the direction of the arrow F. With reference numeral 5 are indicated takeup pulleys which act upon the lower section of the conveyor 1, which are completely or partially coated with electrically insulating material, while with reference 6 is indicated the connection to heart of the whole metallic frame for the support of the same conveyor. To one of the rollers 2, 3, or to the motorization unit 4 (FIG. 5), is associated an encoder 104 or another suitable mean from which it is possible to derive the function relative to the linear displacement of the conveyor 1, to active and de-active in correct phase the guns for the delivery of the powders, as forward stated.

From FIG. 3 it is noted that the upper section of the conveyor 1 runs upon a plate 7 made of electrically-insulating material, for example made of suitable plastics, fixed upon a possible metallic wall 8 or which is directly resting, with its longitudinal edges, upon rests 9, 9′ fixed to the frame 10 of the machine.

The machine which is referred to can be provided with at least two painting chambers 11, 11′ placed in succession, the bottom of which is formed by the upper section of the conveyor 1. The side walls 12, 12′ of the chambers 11, 11′ are made with panels of electrically-insulating material, transparent if required and with the inferior side resting upon supports “U” shaped 13, 13′ fixed to the frame of the machine, the same walls being provided externally with handles 14, 14′ and with the upper side being fixed by means of knob-screws 15, 15′ or other suitable means for the quick fixing, to the horizontal reinforced sides of the superior walls 16, 16′ realised with the same material of the side walls and which with the external reinforcement beams 116, 116′ are connected to the portal beams 110 of the frame 10 of the machine, with the interposition of supports 17 made of electrically insulating and vibration damping material. It is clear how at the end of a working cycle of the machine each time that is required to change the colour of the painting powders, it is simple and quick to remove the side walls 12, 12′ to clean the inner surface of the painting chambers.

The clearances of the conjunction zones of the sides of the upper portion of the conveyor 1 with the side walls 12, 12′, are for example closed by means of strips 18, 18′ made of suitable plastics, for example angle-shaped, placed with their oblique side evident and in conjunction between said portions, inferiorly provided with blind holes which co-operate with possible centering and positioning points 19, 19′ fix to said supports 9, 9′ and which with the ends are fixed to points of the frame 10 of the machine placed outside of the painting chambers, the whole in such a manner to be easily and quickly removed for the cyclic cleaning operations of the machine.

The side walls 12, 12′ of the chambers 11, 11′ are longitudinally provided at a short distance from the conveyor 1, with rectilinear windows 20, 20′, having correct width, to which are joined with tight-seal 21, 21′, hoods 22, 22′ downwardly tapered and connected with the inferior mouth 122, 122′ to aspiration means with suitable head, not illustrated. To allow the removal of the walls 12, 12′, the hoods 22, 22′ are for example assembled upon the frame 10 with the possibility to oscillate on transversal axis 23, 23′ and are laterally provided with ears with knob-screws 24, 24′ which can be movably fixed to correspondent threaded attachments of the frame 10. Removing the screws 24, 24′, the hoods 22, 22′ may oscillate in displacement from the walls 12, 12′, which can be removed. With numeral references 222, 222′ are indicated handles to facilitate the removal of the upper covers of the hood 22, 22′, each time that these must be internally cleaned.

As mentioned in the previous patent application and as everybody knows in the state of the art, suitable means can be provided to allow that the inner surfaces of the walls 12, 12′ and 16, 16′ of the painting chambers 11, 11′, can be maintained at an electric potential which is capable to push back the painting powders, avoiding in this manner the dirty.

From FIGS. 1 and 2 it is noted that the conveyor 1 projects with a correct section of its ends opposed to the inlet door of the chamber 11 and from the outlet door of the chamber 11′, said doors of the chambers being provided with closing walls 25, 25′ which are distant with the inferior side from the upper portion of the conveyor 1, in such a manner as to not interfere with the products with higher thickness which can be painted by the machine which is referred to.

At the inlet of the machine, are provided sensors 26 for example of the optoelectronic kind, which detect the beginning and the end of the products P to be painted and which in co-operation with the encoder 104 mentioned with reference to the FIG. 5, control the activation and the de-activation of the delivery guns for the painting powders, as further described.

Supported for example by the wall 25 of the inlet door of the chamber 11 or by own means, at a correct distance by said wall it is provided with parallel and transversal disposition with respect to the conveyor 1, having a suitable distance from the same conveyor and if required adjustable with suitable means not shown, a bar 27 for the electrostatic charging, downwardly oriented with its emitter points and pre-arranged to charge with electric charges having a predetermined sign, for example negative sign, the external surface of the conveyor 1 and the visible surface of the wood products P which run under said bar and which are resting upon the same conveyor 1. We do not disclose here the constructive and functional details of the charging bar 27, because said component is easily obtainable on the market, even if for uses which are different from the uses of the present invention, and also because it is possible to obtain in experimental way to define the better functioning features of a said apparatus.

The consecutive ends of the chambers 11, 11′ are opportunely spaced out between them and between the same is placed with an inclination inferior to 90° with respect to the longitudinal axis of the conveyor 1, preferably with an inclination of about 45°, a horizontal beam 28 which is very resistant to the flexion, for example with an overturned U shape (see FIG. 6), which with the portion placed in the centre of the conveyor is connected with driving and vertical motion means, which comprise for example a couple of ball bushings or sleeves 29, sliding upon a corresponding couple of vertical bars 30 fixed with their inferior end upon a horizontal plate 31 which is placed under the beam 28 and distant from the conveyor 1 in such a manner which not interfere with the greater thickness handworks or products which can be painted from the machine. With the upper end the bars 30 are fixed to a horizontal plate 31′ which is supposed, for the moment, to be integral to a high portion of the frame 10 of the machine. Between the same plates 31, 31′ are fixed the ends of screws 32, 32′ having the same features, which are parallel to said bars 30 and with which co-operate nut-screws 33, 33′ rotatably assembled upon the beam 28, connected by means of a motion positive transmission 34 for example with pinion and chain and which can be driven by means of a handwheel 35 by means of which it is possible to adjust the level position of the beam 28 and of the components assembled upon this one. From FIG. 1 it is noted that the beam 28 projects with little portions having the same length from the opposite sides of the conveyor 1 and carries fixed to the ends and beyond the centre line, couples of equal and parallel plates 36, 36′, which are oriented towards the opposite chambers 11, 11′, and which support in parallel to the beam 28 and at an inferior level, respective bars 37, 37′ made of suitable electrically insulating material, which with one end are placed about at the level of one of the opposite sides of the upper portion of the conveyor 1 and which with the other ends are placed upon the overall dimensions of the same conveyor and at a correct distance from the other of the opposite sides of the same conveyor. From details of FIGS. 7 and 8 it is noted that the bars 37, 37′ are provided with a plurality of transversal, through and equispaced holes 38, with the same diameter, which are passed through by means of tubes 139, 139′ made of insulating plastic material, connected with a bundle end to the guns of known type 39, 39′, which feed the powdered paints which are electrostatically charged with electrical charges having an opposite sign to the one of the electrostatic charging of the products to be painted, fixed for example with a vertical disposition upon brackets 40, 40′ integral and projecting to the opposite sides of the beam 28 (FIG. 6). The tubes 139, 139′ project with a portion having the same length from the bars 37, 37′ and are fixed in their relative holes by means of friction or by means of radial screws 41, 41′, made of electrically insulating material. The portions of the tubes 139, 139′ which are projecting from the bars 37, 37′ can be oriented with a light downwardly inclination, or they can be substantially horizontal or can be oriented with a light upwardly inclination. For this purpose, the ends of the bars 37, 37′ are fixed to support plates 36, 36′ with means 42 which, if required, allow to rotate the same bars around their longitudinal axis, to orientate in the more suitable manner the painting combs obtained by said terminal portions of the tubes 139, 139′, from which come out upon command the powdered paints.

From FIGS. 1 and 9 it is noted that the painting chambers 11, 11′ are laterally and at the level of the painting bars 37, 37′, are provided with projecting parts 111, 111′ and 211, 211′ having a triangular shape, the first of which incorporate the ends of the same bars which arrive on the edge of the conveyor 1, while the other have the only object to keep apart the portions of the lateral walls of the chambers which otherwise may result too much close to the powders delivery tubes, to avoid the dirtying of said walls. Said lateral projections 111, 111′, and 211, 211′ of the chambers 11, 11 ′ are laterally closed up to the conveyor 1, are closed superiorly and inferiorly, but can be provided with little openings 43 as from the FIGS. 2 and 9, so that from these openings enters the air sucked from the hoods 22, 22′, in order to avoid stagnation zones in the lateral projections which is referred to. According to the embodiment shown in the FIGS. 1 and 9, the outlet door of the chamber 11 and the inlet door of the chamber 11′have in plan view a broken shape which is substantially like an S, or a Z, with two portions which are parallel to the bars 37, 37′, and are for example opened for the whole height, so that the powders delivery guns 39, 39′ are placed upon said doors, in order to be continuously washed by means of the air flow sucked by the hoods 22, 22′, which prevent the escape of particles powdered paints from the painting chambers.

According to the preferred embodiment shown in the FIGS. 1a and 9a, the outlet and inlet doors of the chambers 11 and 11′ have a plan shape like an L with a wide portion which is parallel to the bars 37, 37′ so that the guns 39, 39′ result all outside of said doors which are provided with respective frontal walls 311, 311′ which close the same for a wide upper portion, up to a short distance from the painting bars 37, 37′, allowing to said bars the required regulation of the level position with the variation of the thickness of the products to be painted. In this case it is possible that on the inferior side of the said walls 311, 311′, can be fixed curtains made of flexible material, not shown, which come in contact with the painting bars 37, 37′. This solution, which is illustrated in a better manner in the diagram of FIG. 1b, has the object to maintain the guns 39, 39′ completely outside of the painting chambers, both to avoid the dirt and to facilitate the feeding of the same to the electricity and to the powdered paints, which came from the top by means of delivery feeding cables and tubes, not shown. The painting bars 37, 37′ which support the feeding ends of the tubes 139, 139′ are placed on the doors of the painting chamber/s 11 and are therefore continuously licked up by means of the air flow sucked by the same doors by the depressurisation circuit of the cabin, which is flowing in the same direction with the flow of the powdered paints delivered by the same bars and that therefore maintains the same bars always perfectly clean. It is to be understood that differently to what shown in FIG. 1b, in the field of the invention are comprised also the little variations according to which the delivering spout of the tubes 139, 139′ may be placed exactly on the door of the painting chamber or inside the same door.

In order to render more regular the distribution of the powders upon the product to be painted which passes under the painting bars 37, 37′, it may be provided that the upper plate 31′ of the FIGS. 2 and 3 is assembled upon a carriage 44 sliding upon horizontal guides 45 supported by the upper portion of the frame 10 of the machine and orthogonal to the conveyor 1, said carriage being connected to a rectilinear alternate movement actuator 46, for example to a little fluid pressure cylinder-piston group, anchored with the body to the frame 10. According to one variation, the guides 45 may be oriented in a parallel manner to the beam 28 and to the painting bars 37, 37′.

In the FIGS. 2 and 3, with 48 is indicated a tracked guide which carries the tubes and the cables for the feeding of the guns 39, 39′, and the tubes for the feeding of the possible cylinder 46 which with one end is anchored to a portal structure 49 superiorly bridged between the chambers 11, 11′, in such a manner that said ducts and cables can be connected to fixed feeding and control portions (not shown).

The machine is completed by at least a hood 50 (FIG. 4 and 5), placed at the beginning of the inferior portion of the conveyor 1, in the high portion of which acts a rotary brush 51, driven by the group 151, which detaches from the same conveyor the powdered paints not removed by means of the first aspiration effect of the hood of which is referred to, in such a manner that these may be evacuated and recovered with known systems and in a manner that the same conveyor comes back clear upon the upper portion. It is to be understood that the brush 51 may be placed in a hood, immediately downwardly of the one with the numeral reference 50. The hoods which are referred to can be connected to the same powders aspiration and/or recovering circuit which maintains in depression the painting chamber/s of the machine.

The working of the machine so conceived is simple and evident. The suction hoods 22, 22′ work continuously, while the guns 39, 39′ and if necessary also the loading rod 27 are inactive in absence of the product to be painted. When an product P placed upon the conveyor 1, passes at the level of the sensor 26 (FIG. 1), the control switchboard of the machine detects by means of said sensor the presence and the relative position of the same product with respect to the operating members of the machine and in correct phase, also in co-operation with the encoder 104 associated to the conveyor 1, at first commands the activation of the rod or bar 27 which electrostatically charges electrostatically the same products P and the conveyor 1, for example with electrostatic charges having a negative sign. The good superficial electrostatic conductivity of the conveyor 1 will favour the equal distribution of the negative electrostatic charges upon the whole visible surface of the product P, also on the edges and also in the zone of contact with the same conveyor.

When then the product is going to arrive at the level of the painting bar 37, the relative guns 39 are automatically activated and the powdered paint which is charged, for example, with positive electrostatic charges, comes out from the group of tubes 139 supported by means of said bar 37 and when the product comes at the level of the tubes 139, the powdered paint is distributed in a uniform and direct manner upon the upper surface A, the front B and upon the side C of the same product, thanks to the particular sloping collocation of the painting rod 37, while the rear front D and the side E of the same product are poorly interested by the first powdered paints, because are not exposed to the direct action of the tubes 139 of the rod 37. The excess powders which are not remained attached to the product P, partly remain attached to the upper portion of the conveyor land partly follow the air flow sucked by the hoods 22 of the painting chamber 11 and arrive to the same cyclone which collects the powders evacuated by means of the final cleaning system 50, 51 of the conveyor 1. From the inlet and outlet doors or mouths of the chamber 11, enters a continuous flow of air which licks up the painting rod 37 and which maintains the whole perfectly clear. When the product passes over the painting rod 37, the switchboard, which as above mentioned knows in every moment the position of the same product with respect to the operative members of the machine, command the stop of the guns 39 if in the succession there lack further products.

Before the product arrives in the painting chamber 11′, in correct phase are activated the guns 39′ which distribute the powdered paint, in the same direction of the travel direction of the product, and therefore with uniformity of distribution interesting another time the superior surface A of the same product, and, thanks to the particular slant of the rod 37′, interesting in a uniform, complete and direct manner both the side E and the posterior front D of the product, while the front B and the side C are interested in a less effective manner from the powders also because already effectively painted during the passing through of the previous painting chamber. Also in this case the surplus of powder which has not interested the product P, partly remain attached to the conveyor 1 and partly are removed by means of the lateral suction hoods 22′. The product recovered with powdered paints over the whole visible surface, is transferred from the conveyor 1 to a next conveyor of the plasticization and catalization-hardening tunnel of the powdered paints, while the same conveyor 1 is deprived of the powders which remain attached by means of the electrostatic charge, during the passing through of the cleaning unit 50, 51 above mentioned. If required, other suitable cleaning means of any suitable mechanical and/or electrostatic kind may be provided for example at the level of the inferior transmission roller 5 of the conveyor 1.

It is understood that the improvements above described for a machine with two consecutive painting chambers, are intended to be protected also in a machine with a single painting chamber. FIGS. 10 and 12 show a said machine with a single chamber 11, which, differently from the preceding solutions has the painting elements which are placed always at 45° on the inlet and outlet doors of the same chamber, but which are contained in the overall dimensions of the conveyer 1, so that the said chamber may has a simplified shape, without the lateral projections 111, 111′ and 211, 211′ above mentioned. Differently from the preceding solution, according to which at least the lateral walls of the painting chambers were disassemblable for the internal cleaning of the same chambers, in the embodiment which is referred to the chamber 11 may be realised with a suitable material having a high degree of electric insulation an may be fixed by means of tie bars 52 to an external support frame 53 having a shape like an overturned L, horizontally hinged in 54 to a shoulder 210 of the frame 10 of the machine. When the frame 53 is in low position shown with a continuous line in FIG. 12, the chamber 11 results to be with its own frontal walls 311, 311′ to a short distance from the upper portion of the conveyor 1 and touches said conveyor with an inferior and flexible extension 411 of its own lateral walls. The frame 53 is connected to the shoulder 210 by means of gas springs 55. With the assistance of said springs it is possible to raise up and to maintain raised the frame 53 with the attached painting chamber 11, as shown with a dotted line in the FIG. 12, in order to proceed to the inspection and/or to the internal cleaning of the chamber 11, for example each time that the colour of the powdered paints is changed. The upper wall of the chamber 11 is provided with a feed opening 56 connected to the suction circuit, not shown, which maintains the same chamber in the correct depression.

In order to allow a wide possibility for the regulation of the level position and a more easy regulation of the slant of the painting rod 37, 37′, in the machine as from the FIGS. 10, 11 and 12 it is provided that each support structure 28 of the guns 39, 39′ slides upon respective pair of vertical guides 30 fix to the lintel of a portal structure 149 integral to the frame of the machine and upon which are assembled screw means or other kind of means for the level adjustment of said structures 28 which carry inferiorly, book-hinged, by means of hinges 57, 57′, the minor sides of respective trapezoidal shaped frame, turned toward the painting chamber with their major side ribbed which forms the painting bars 37, 37′ and which for the purpose is provided with the plurality of holes 38 having the same distance in which are snap-inserted and with the same projection the ends of the tubes 139, 139′ which derive from the guns 39, 39′ for the feeding of the powdered paints. In a median point of the structures 28 is rotatably mounted upon a rest horizontally articulated 58, a wheel nut-screw 59 which co-operates with the screw 60 hinged with the inferior end at 61 with the frame with the bars 37 or 37′, the whole in such a manner that acting upon said wheel it is possible to modify the slant and the orientation of said bars, as shown in FIG. 11 with continuous line and with dotted line. From FIGS. 10 and 11 it also appears that upon the major side of the bars 37, 37′ rests the inferior portion 162 hood shaped of a little vertical wall 62 which is vertically sliding with the ends in vertical guides 63 and which externally surmounts the frontal walls 311, 311′ of the painting chamber 11, to form doors with an adjustable height with the variation of the slant and/or of the level position of the painting bars.

It is to be understood that the description is referred to a preferred embodiment of the invention, to which can be brought numerous constructive variations and modifications, the whole however without leaving the informing principle of the invention, as described, as illustrated in the seven attached sheets of drawings and claimed hereinafter. In the claims, the references between brackets are merely indicative and not limitative of the limits of protection of the said claims.

1) Machine for the horizontal painting with powdered paints, of three-dimensional and mainly flat wood products or its by-products, of the type comprising a horizontal and motorised conveyor (1) upon which are resting the products to be painted which by suitable means are referred to an electric potential having a predetermined sign and which by the same conveyor are driven to pass through at least one chamber (11) connected to suction means which maintain the same in depression with respect to the external environment, because in said chamber are delivered by suitable means the powdered paints electrostatically charged with electric charges having an opposite sign to the one of the products, to strictly adhere to the same products, the whole in such a manner that the particles of powder do not exit from the inlet and outlet mouths or doors of said chamber because of the suction effected by said suction means, characterised by the fact that the delivery means of the electrostatically charged painting powders, are placed at least at one or both of the doors of the said chamber (11), so that are continuously licked up by the depressurisation airflow of the same painting chamber, which prevents the deposit upon said means of powdered paint and which therefore maintains said means always perfectly clean.

2) Machine according to claim 1, in which the delivery means for the powdered paints are placed just outside of the opening space of the doors of the painting chamber (11).

3) Machine according to claim 1, in which the delivery means for the powdered paints are placed in the opening space of the doors of the painting chamber (11).

4) Machine according to claim 1, in which the delivery means for the powdered paints are placed inside the painting chamber (11), just beyond the opening space of the doors of said chamber (11)

5) Machine according to claim 1, in which the delivery means for the powdered paints placed at the inlet and/or outlet door/s of the painting chamber (11) are constituted by the terminal ends arranged to form a horizontal comb, of the tubes (139, 139′) of electrically insulating material and connected in a bundle to the feeding guns (39, 39′) for the powdered paints electrostatically charged, which guns are assembled upon any support structure placed in proximity, preferably at an upper level with respect to the one of the said painting comb and outside of the painting chamber.

6) Machine according to claim 5, in which the delivery guns (39, 39′) for the powdered paints electrostatically charged, are distant from the inlet and/or outlet mouths or doors of the painting chamber (11) in such a manner that they are not interested by the air flow which enter through said mouths or doors.

7) Machine according to claim 6, in which said guns (39, 39′) are protected at least inferiorly or also laterally by means of a suitable structure (28, 40, 40′) having, if required, support functions for the same guns.

8) Machine according to claim 5, in which the feeding ends for the powdered paints of the tubes of insulating material (139, 139′) connected in a bundle to said guns (39, 39′) are supported in a comb-like manner, with the same reciprocal distance and projection, and with planar alignment, by means of bars (37, 37′), preferably made of electrically insulating material.

9) Machine according to claim 8, in which any feeding element for the powdered paints, comprises a bar (37, 37′) placed parallelly and transversally over the conveyor (1) for the support and the advancement of the products to be painted (1), the ends of said bar being supported by means of pairs of support plates (36, 36′) and with means (42) which allow to rotate the same bars around their longitudinal axis and to orientate in the required manner the projecting ends of the feeding tubes (139, 139′) of the powdered paints.

10) Machine according to claim 9, in which the support plates (36, 36′) for the ends of the painting bars (37, 37′) are assembled upon a frame (28) which supports the guns (39, 39′) and which is secured to the frame of the machine with means (29-35) which allow to adjust the level position of the whole complex in accordance with the variation of the thickness of the products to be painted.

11) Machine according to claim 8 in which the feeding bars (37, 37′) for the powdered paints are formed by the side of flat frames which with the opposite side are book-hinged to a respective support structure (28) which supports the guns (39, 39′) and which is secured to the frame of the machine with means (29-35) which allow to modify the level position of the whole unit in accordance with the variation of the thickness of the products (P) to be painted, each frame for the formation of said painting bars being connected to the overhanging support structure (28) with interposed adjustment means (58-61) for the adjustment of the slant and of the orientation of the delivering ends of the tubes (139, 139′) fixed to the same bars.

12) Machine according to claim 8, in which the painting bars (37, 37′) are provided with a plurality of transversal and equidistant through holes (38) which are traversed by the tubes (139, 139′) made of electrically insulating material and connected in a bundle to the guns (39, 39′) which feed the electrostatically charged powdered paints, said tubes being fixed in said holes due to friction and/or by suitable means (41) and with the same projection from the same bar and their projecting ends being oriented toward the inside of the painting chamber, on the path of the products to be painted.

13) Machine according to claim 1, in which the delivery ends of the tubes (139, 139′) which are projecting from the same painting bars (37, 37′) are downwardly oriented.

14) Machine according to claim 1, in which the delivery ends of the tubes (139, 139′) are substantially oriented on the horizontal.

15) Machine according to claim 1, in which the delivery ends of the tubes (139, 139′) are upwardly oriented in order to form an angle of few degrees with respect to the horizontal plane.

16) Machine according to claim 8, in which the painting bars (37, 37′), placed for example upon the opposite ends of a painting chamber (11) form with the longitudinal axis of the conveyor (1) an angle which is lesser than 90° and are parallel in a such a manner to distribute uniformly the powdered paints, also on the opposite sides (C, E) of the products (P) to be painted.

17) Machine according to claim 16, in which the painting bars (37, 37′) are oriented with an angle of about 45° with respect to the longitudinal axis of the underlying conveyor (1).

18) Machine according to claim 8, in which the support structure/s of the painting bars (37, 37′) can be provided with means (44-46) to give to the same painting bars an alternate horizontal displacement, orthogonal to the longitudinal axis of the underlying conveyor or aligned to the longitudinal axis of the same bars.

19) Machine according to claim 1, characterised by the fact that the painting chamber is formed with a hood of electrically insulating material, provided at the ends with walls (311, 311′) with bottom doors for the inlet and the outlet of the products, laterally provided with longitudinal and flexible lips (411) which are in contact with the underlying conveyor (1), the same chamber being connected to an external support frame (53) in its turn laterally book-hinged to the fixed frame of the same machine, along an axis (54) which is parallel to the longitudinal axis of the same conveyor and, if required, means (55) being provided to raise and to maintain raised said hood, to inspect and clean internally the same.

20) Machine according to claim 19) in which the hood which is forming the painting chamber (11) is provided in a upper portion with at least one connection (56) to a suction duct.

21) Machine according to claim 1, characterised by the fact that it is provided with two painting chambers (11, 11′) placed the one following the other and longitudinally traversed by a single conveyor (1), said chambers being between them suitably distanced by their consecutive ends, at the level of which are placed respective means for the delivery of the powdered paints, the whole in such a manner that the last delivery phase of the powdered paints is effected in the same direction of the advancement of the products, to ensure a good uniformity of the deposition of the same powders.

22) Machine according to claim 21, in which the first painting chamber (11) may be provided with delivery means for the powdered paints also at the inlet door.

23) Machine according to claim 21, in which the delivery bars (37, 37′) for the powdered paints and the guns (39, 39′) which operate upon the consecutive ends of the two painting chambers (11, 11′) are connected to a common support structure (28) with relative means (30-35) for the registration of the level position and, if required, means (44-49) for the alternate handling.

24) Machine according to claim 1, in which the painting chamber/s (11, 11′) are provided on the lateral walls (12, 12′) with longitudinal windows (20, 20′) which are parallelly placed and which are at a short distance from the conveyor (1) and externally connected to suction hoods (22, 22′).

25) Machine according to claim 24), in which the suction hoods (22, 22′) are assembled upon the frame (10) of the machine with the possibility to oscillate upon axes (23, 23′) which are parallel to the longitudinal axis of the same machine and which are predisposed for the fastening with screws (24, 24′) to the same frame, so that their suction mouth provided with suitable gaskets (21, 21′) can be maintained connected with the lateral windows (20, 20′) of the painting chambers, while by removing said screws the hoods may oscillate toward the exterior and moved away from the lateral walls of the painting chambers, to allow the inner cleaning and ordinary maintenance operations of the same chambers (11, 11′).

26) Machine according to claim 21, in which the painting chambers (11, 11′) have lateral walls (12, 12′) made with panels externally provided with handles (14) and which with their lower side co-operate with U shaped supports (13, 13′) laterally fixed to the support frame of the conveyor (1), while the upper sides of said walls are fixed with screws (15) or other quick fasteners to the panels which form the upper walls (16, 16′) of said chambers and which with their external ribs are fixed to the portal beams (110) of the support frame (10) of the machine, with the interposition of electrically insulating and vibration damping supports (17)

27) Machine according to claim 26, in which the sides of the upper portion of the conveyor (1) are slightly displaced from the lateral walls (12, 12′) of the painting chambers (11, 111′) and from said free zones are projecting projections (19, 19′) upon which are inserted with their lower seats, angle-protection structurals (18, 18′) which touch said lateral walls and which closely surmount a correct portion of said conveyor, said structurals being fixed in a removable manner to the frame of the machine with their portions outside of the painting chambers.

28) Machine according to claim 1, in which the front walls (311, 311′) of the painting chamber/s, have their lower side which is far from the conveyor (1) and on the external side of said walls are slidably mounted in suitable vertical guides (63) respective walls (62) the lower portion of which forms a little hood (162) projecting outwardly and which surmounts the delivery bars (37, 37′) for the powdered paints.

29) Machine according to claim 1, in which the products to be painted and the upper portion of the conveyor (1) which support them, are electrostatically charged which electric charges having opposite sign to the one of the powdered paints, by any suitable means (27) placed upon the conveyor of the products and under which the same products runs before entering in the painting chamber, with their visible surfaces to be painted which result in such manner directly subjected to the action of said electrostatic charging means.

30) Machine according to claim 29, in which the electrostatic charging means of the products to be painted comprise an electrostatic charging bar (27) placed transversally upon the conveyor (1) of the same machine, at a correct distance from this and oriented in the direction of said conveyor with its emission points of the electrostatic charges.

31) Machine according to claim 30, in which the electrostatic charging bar (27) is such to charge the products to be painted for example with electric charges having a negative sign, while the powdered paints are electrostatically charged for example with electric charges having a positive sign.

32) Machine according to claim 29, in which the conveyor (1) is realised with electrostatically insulating materials and at least its visible surface is characterised by a good conductivity of the electrostatic charges.

33) Machine according to claim 32, in which the upper portion of the conveyor (1) slides upon a support and guide structure (7) made with electrically insulating material, means (6) to connect and to refer to earth all the metallic portions of the frame of the same conveyor being provided.

34) Machine according to claim 1, in which in the terminal section and at least in the initial section of the lower portion of the conveyor (1) operate at least a suction hood (50) and mechanical means constituted for example by a rotary brush (51) housed in said hood or in a pertaining suction hood, to remove the residual powders of painting from the same conveyor, said means being connected for example to the same suction circuit of the painting chamber/s and/or being connected to the same circuit which flows into a cyclone and/or into others suitable means for the damping and the recovery of the powdered paints.
